(19) United States
(12) Patent Application Publication
(10) Pub. No.: US 2006/0265219 A1
(43) Pub. Date: Nov. 23, 2006

(54) Noise level estimation method and device thereof

(76) Inventor: Yuji Honda, Tokyo (JP)

Correspondence Address: RABIN & Berdo, PC, 1101 14TH STREET, NW, SUITE 500, WASHINGTON, DC, 20005, US

(21) Appl. No.: 11/408,930

(22) Filed: Apr. 24, 2006

(30) Foreign Application Priority Data
May 20, 2005 (JP) 2005-147535

(51) Int. Cl. G10L 15/20

(52) U.S. Cl. 704/233

(57) ABSTRACT

A noise level estimation device defines a short time frame and a long time frame. The long time frame includes a plurality of short time frames. The noise level estimation device has a first. calculating unit to calculate the short time power of an input speech signal for each short time frame. Thus, a plurality of short time powers are prepared for a single long time frame. The noise level estimation device also includes a second calculating unit to calculate the smallest one of the short time powers. An output unit of the noise level estimation device takes the smallest short time power as the estimated background noise level of the input speech signal.

### BACKGROUND OF THE INVENTION

1. Field of the Invention

The present invention relates to a noise level estimation method and device thereof that are used in speech communication systems such as telephones and wireless devices adapted to transmit input speech signals, and that are used in methods and devices such as speech recording devices and speech recognition devices adapted to process speech signals.

2. Description of the Related Art

Conventionally, in the following devices (a) to (c), for example methods for estimating background noise levels and estimation devices are useful.

(a) Telephones and Wireless Devices

In speech communication systems, transmission costs can be reduced by transmitting only signals of speech segments and by differentiating the encoded bit distribution amount between speech segments and speechless segments. By calculating the speech-detection threshold value in accordance with the background noise level in order to improve the detection accuracy of the speech segments, the transmission efficiency and communication quality can be improved.

By adding comfort noise to the speechless segments produced by a nonlinear processor (NLP) that is used in an echo-suppression device or a transmitter (Voice Operated Transmitter; VOX) adapted to perform transmission by switching speech and speechless segments, the artificial nature of the call and discomfort can be reduced. To this end, adjustment of the comfort noise addition level, which corresponds with the background noise level, is required.

(b) Speech Recording Devices

If a device records speech to a semiconductor memory, the semiconductor memory can be used efficiently by recording only the continuous time of a speechless-segment signal without encoding same and switching (changing) the encoded bit allocation amounts in the speech segments and speechless segments. Like the speech communication system, the semiconductor memory capacity can be reduced by calculating an appropriate speech-detection threshold value in accordance with the background noise level.

(c) Speech Recognition Devices

In the case of a speech recognition device, the speech recognition rate can be improved by calculating an appropriate speech detection threshold value in accordance with the background noise level.

One example of conventional noise level estimation devices that are used in such applications is disclosed in Japanese Patent Application Kokai (Laid Open) No. H10-91184 (particularly FIG. 4 of this Japanese publication).

FIG. 8 of the accompanying drawings is a schematic view of the noise level estimation device shown in FIG. 4 of Japanese Patent Application Kokai No. H10-91184.

This noise level estimation device includes an input terminal 1 to which a speech signal In is introduced from a microphone or the like. Connected to the input terminal 1 are a power calculation device 2, a threshold value calculation device 3, a speech detection device 4 that controls the calculation devices 2 and 3, an output terminal 5 that generates a speech/speechless judgment signal out, and an output terminal 6 that outputs the calculated average power P.

The power calculation device 2 calculates the average power P from the moving average or smoothed value of a short time of an input speech signal in and supplies the average power P to the threshold value calculation device 3. The threshold value calculation device 3 outputs a threshold value Pt rendered by adding a fixed value to the average power P, to the speech detection device 4. The speech detection device 4 compares the power of the input speech signal in with the threshold value Pt, and determines that speech is present when the power of the input speech signal in exceeds the threshold value Pt. The speech detection device 4 then supplies a speech/speechless judgment signal out to the output terminal 5, and stops the update operation of the power calculation device 2 and threshold value calculation device 3. The average power P issued from the power calculation device 2 is prepared from the power of only the segment(s) judged to be speechless. Thus, it can be considered that the average power P represents the level of the background noise.

In the level estimation device of FIG. 8, however, the value of the average power P, which is calculated by the power calculation device 2 by means of computation of the moving average or smoothed value based on past information, changes gradually under some influences of the past information. Therefore, even when the background noise level of a few segments only exists between phrases, the value of the average power P does not drop sufficiently to the background noise level and there is the possibility that the detection of the background noise level will be disabled. Further, if a speechless segment is not correctly detected, the background noise level cannot be estimated correctly either.

Methods that handle spectra such as linear predictive coding (LPC) or fast Fourier transforms (FFT) have also been proposed in order to increase the accuracy of the speech detection device 4. However, when such methods are compared to the method that compares the power of the input speech signal In with the threshold value Pt as per the arrangement shown in FIG. 8, the circuit scale or amount of calculations exhibits a clear increase.

### SUMMARY OF THE INVENTION

An object of the present invention is to provide a noise level estimation method and device thereof that estimate the noise level easily and simply without the need for a speech detection device.

The noise level estimation method and device thereof according to a first aspect of the present invention use a concept of a short time frame and a long time frame. A portion of an input speech signal is defined as the long time frame. A plurality of short time frames define the long time frame. A power of each of the short time frames of the long time frame (i.e., short time power) is calculated. Then, the smallest short time power is calculated from among the calculated short time powers. The smallest short time power is taken as the estimated noise level of the input speech signal.

Because the present invention does not require a speech detection device, the present invention can provide highly accurate noise level estimation that does not depend on detection results of the speech detection device. The variety of approaches proposed conventionally in order to increase the accuracy of the speech detection device are no longer necessary, and an estimation of the noise level can be performed by means of a smaller circuit scale and/or a smaller amount of calculation. The present invention can cope with even when continuous speech that exceeds the long time frame is inputted. Specifically, the present invention utilizes a fact that one or more speechless segments having a length of at least single short time frame normally exist between phrases even when such continuous speech is inputted. Thus, the smallest short time power in a certain long time frame can be taken as the estimated noise level. It should be noted that the calculation of the short time power is carried out (finished, completed) for every short time frame. Therefore, even when a speech signal is included in another short time frame before or after the short time frame having the smallest short time power, there is no effect on the estimation result. As a result, the noise level in a short period that exists between the phrases can be detected.

The noise level estimation of the present invention can be applied to speech communication systems such as telephones and wireless communication devices. Also, the present invention can be applied to speech recording device and speech recognition devices that performs speech signal processing.

When the short time power of the input speech signal that is smaller than the estimated noise level is detected, the estimated noise level may be updated by the detected short time power. This stands on a principle that the smallest short time power in an arbitrary long time frame is taken as the estimated noise level. If the short time power smaller than the current estimated noise level is detected, then this smaller short time power is taken reflected in the estimated noise level. Accordingly, accuracy of the estimation is improved further.

### BRIEF DESCRIPTION OF THE DRAWINGS

FIG. 1 is a function block diagram of a noise level estimation device according to a first embodiment of the present invention;

FIG. 2 shows the concept of short time frames and long time frames employed in the first embodiment of the present invention;

FIG. 3 is a waveform diagram showing output signals of the respective units in the noise level estimation device of FIG. 1;

FIG. 4 is a flowchart showing the noise level estimation processing performed by the noise level estimation device shown in FIG. 1;

FIG. 5 is a waveform diagram that shows output signals of the respective units in the noise level estimation device according to the second embodiment of the present invention;

FIG. 6 is a flowchart showing the noise level estimation processing carried out by the noise level estimation device of FIG. 5;

FIG. 7 is a waveform diagram of the noise level estimation obtained in the second embodiment, which shows the power of the input speech signal and the estimated noise level; and

FIG. 8 is a schematic block diagram of a conventional noise level estimation device.

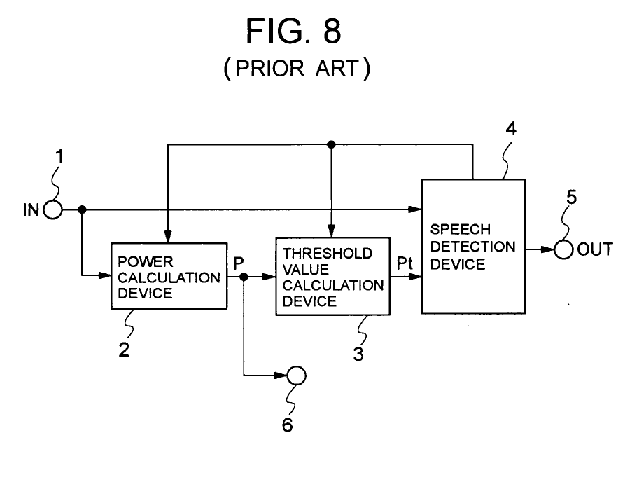

### DETAILED DESCRIPTION OF THE INVENTION

### First Embodiment

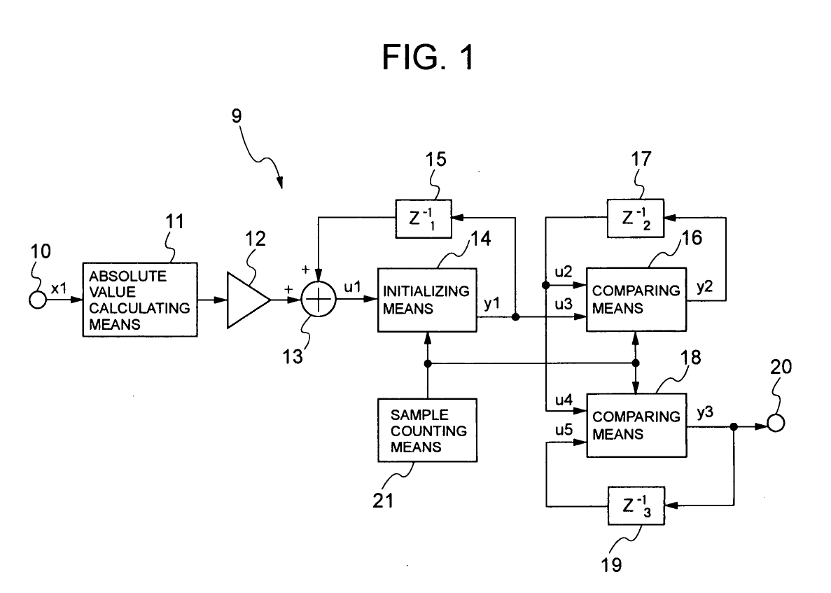

Referring to FIG. 1, a noise level estimation device 9 of the first embodiment will be described. The noise level estimation device 9 estimates the level of the noise (background noise, for example) of a speech signal x1. The speech signal x1 is introduced to an input terminal 10 from a microphone or the like. The noise level estimation device 9 generates an output signal (i.e., estimated value) y3 from an output terminal 20. The noise level estimation device 9 is constituted by hardware (individual circuits) that runs on an electronic circuit or by software that runs on a microcontroller or a digital signal processor (DSP) or the like.

The noise level estimation device 9 includes an absolute value calculator (absolute value calculation means) 11 that are connected to the input terminal 10. A multiplying unit (multiplication means) 12, dual-input single-output adder (addition means) 13, and initializing unit (initializing means) 14 are vertically connected to the absolute value calculator 11. A one-sample (Z⁻¹₁) delay unit (one-sample delay means) 15 is feedback-connected between the output terminal of the initializing unit 14 and the input terminal of the adder 13.

The absolute value calculator 11 calculates the absolute value of the inputted speech signal x1 and is constituted by a hardware absolute-value calculation device or software computing means, for example. The multiplying unit 12 multiplies the output signal of the absolute value calculator 11 by a predetermined value and is constituted by a hardware multiplier or software computing means, for example. The adder 13 adds the output signal of the multiplying unit 12 and the output signal of the one-sample delay unit 15 and is constituted by a hardware adder or software computing means, for example. The initializing unit 14 normally outputs an input signal u1 from the adder 13 as is as an output signal y1 and generates a 0 for a predetermined number of samples (128 samples, for example). The initializing unit 14 is constituted by a hardware initialization circuit or software resetting means, for example. The one-sample delay unit 15 holds the output signal y1 of the initializing unit 14 by delaying the output signal y1 by one sample (Z⁻¹₁) and sending the delayed output signal y1 as feedback to the adder 13. The one-sample delay unit 15 includes a hardware one-sample delay memory or the like or software delay means, for example.

The first calculator (power calculating unit, for example), which calculates the power (y1) of the inputted speech signal x1, is constituted by the absolute value calculating unit 11, multiplying unit 12, adding unit 13, initializing unit 14, and one-sample delay unit 15.

A dual-input single-output comparator (comparing means) 16 is connected to the output terminal of the initializing unit 14, and a one-sample (Z⁻¹₂) delay unit (delay means) 17 is connected between the input and output terminals of the comparator 16. A second calculating unit includes the comparator 16 and one-sample delay unit 17. The comparing unit 16 normally outputs an input signal u2 from the one-sample delay unit 17 as is as the output signal y2. However, the comparing unit 16 compares the input signals u2 and u3 every predetermined number of samples (128 samples, for example), that is, each time the input signal u3, which is the value for the short time power from the initializing unit 14, is inputted. In this instance, the comparing unit 16 outputs the smaller of the two values as the output signal y2. The comparing unit 16 is constituted by a hardware comparison circuit or software computing means, for example. The one-sample delay unit 17 holds the output signal y2 of the comparing unit 16 by delaying same by one sample(Z⁻¹₂) and sending the output signal y2 as feedback to the comparing unit 16. The one-sample delay unit 17 is constituted by a hardware one-sample delay memory or by software delay unit, for example.

A dual-input single-output comparing unit (comparing means) 18 is connected to the output terminal of the one-sample delay unit 17, and one-sample (Z⁻¹₃) delay unit 19 is connected between the input and output terminals of the comparing unit 18. An output unit is constituted by the comparing unit 18 and the one-sample delay unit 19. The comparing unit 18 normally outputs an input signal u5 from the one-sample delay unit 19 to the output terminal 20 as is as an output signal y3. However, for every predetermined number of samples (8192 samples, for example), that is, when an input signal u4 that is an initial sample of a long time frame is introduced from the one-sample delay unit 17, the comparing unit 18 outputs the input signal u4 to the output terminal 20 as the output signal y3. For example, the comparing unit 18 is constituted by a hardware comparator circuit or by software computing means. The one-sample delay unit 19 holds the output signal y3 of the comparing unit 18 by delaying same by one sample (Z⁻¹₃) and sending same as feedback to the comparing unit 18. The one-sample delay unit 19 is constituted by a hardware one-sample delay memory or by software delay means, for example.

A sample counter (sample counting means) 21 is connected to the control terminals of the initializing unit 14 and comparing units 16 and 18. The sample counter 21 counts the sampling periods and supplies a timing signal c for informing the initializing unit 14 and comparing units 16 and 18 of the operational timing. The sample-counting unit 21 is constituted by a hardware sample counter or by software counter, for example.

Noise Level Estimation Method

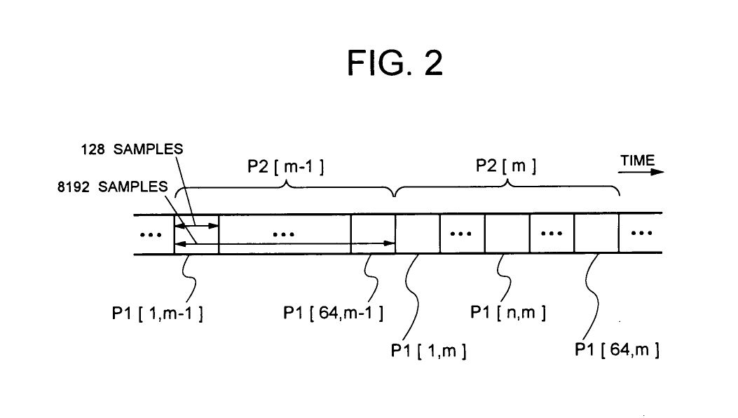

FIG. 2 shows the concept of short time frames and long time frames that are employed by the first embodiment.

In FIG. 2, as an example, 128 samples (16 ms in the case of a sampling frequency of 8 kHz) are defined as the unit length of a short time frame P1 and 8192 (=128×64) samples (1024 ms in the case of the sampling frequency of 8 kHz) are defined as the unit length of a long time frame P2. Naturally, the embodiment need not be limited to such definitions. The m-th longtime frame is denoted as P2 [m] and the n-th short time frame in the long time frame P2 [m] is denoted as P1 [n,m].

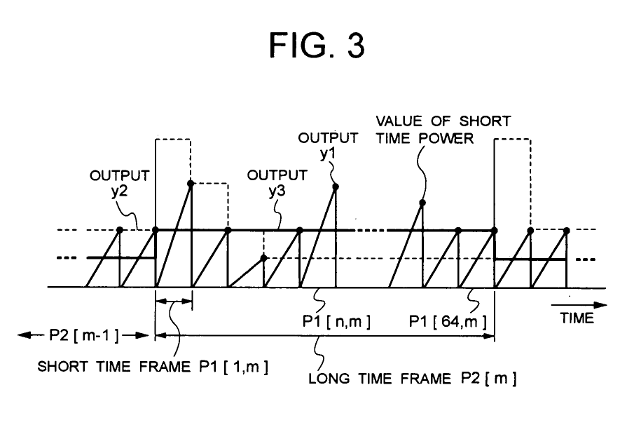

Hereinafter, based on this frame concept, a noise level estimation method that employs the noise level estimation device 9 shown in FIG. 1 will be described with reference to FIG. 3.

FIG. 3 is a waveform diagram that shows the output signals of the respective units in the noise level estimation device 9. Time is plotted on the horizontal axis and the signal level is plotted on the vertical axis.

Suppose that an i-th (i=1, 2, . . . , 128) sample (digital speech signal) in the short time frame P1 [n, m] of the speech signal x1 that is introduced from the input terminal 10 is expressed as xᵢ [n,m]. The absolute value |xᵢ [n,m]| of each of the respective samples xᵢ [n,m] thus inputted are calculated by the absolute value calculator 11. Then, the absolute value |xᵢ [n,m]| is multiplied by 1/128 in the multiplier 12, and the multiplication result is supplied to the downstream adder 13. The initializing unit 14 normally outputs the input signal u1 from the adder 13 as is as the output signal y1 in accordance with Equation (1) below, but outputs 0 every 128 samples. This output signal y1 is stored in the one-sample delay unit 15 and sent to the adding unit 13 in the next sample. The initial value of the one-sample delay (Z⁻¹₁) is 0.

$$y 1 = \{ \begin{matrix}0 & if i = 128 \\ u 1 & otherwise\end{matrix} \qquad ( 1 )$$

The value P1 (n,m) of the short time power of the short time frame P1 [n,m] indicated by Equation (2) in provided as the output signal y1 of the initializing unit 14 every 128 samples by the absolute value calculating unit 11, multiplying unit 12, adding unit 13, initializing unit 14, and one-sample delay unit 15. That is, the initializing unit 14 generates the value of the short time power of the short time frame P1 [n, m] as the output signal y1 after the final sample of the short time frame P1 [n, m] as shown in FIG. 3.

$$P 1 ( n , m ) = \frac{1}{128} {\sum }_{x ∈ i \vert n , m \vert}^{} \vert x \vert \qquad ( 2 )$$

The comparing unit 16 normally outputs the input signal u2 from the one-sample delay unit 17 as is as the output signal y2 in accordance with Equation (3). However, every 128 samples, that is, each time the value of the short time power outputted from the initializing unit 14 is inputted as the input signal u3, the comparing unit 16 compares the input signals u2 and u3 and outputs the smaller value as the output signal y2. When the initial sample (P1 [1,m]) of the long term frame P2 [m] is introduced, the comparing unit 16 outputs a value equal to the initial value of the one-sample delay (Z⁻¹₂). The initial value of the one-sample delay (Z⁻¹₂) unit is the maximum value possible for the one-sample delay unit 17. The output signal y2 of the comparing unit 16 is stored in the one-sample delay unit 17 and is sent to the comparing unit 16 and comparing unit 18 in the next sample. That is, as shown in FIG. 3, the output signal y2 is initialized at the maximum value in the initial sample (P1 [1,m]) of the long time frame P2 [m] and this value is updated when the smallest short time power in the long time frame P2 [m] is detected.

$$y 2 = \{ \begin{matrix} {Z}_{2}^{- 1} initial value & if i = 1 and n = 1 \\ min ( u 2 , u 3 ) & if i = 128 \\ u 2 & otherwise\end{matrix} \qquad ( 3 )$$

The comparing unit 18 normally outputs the input signal u5 from the one-sample delay unit 19 as is as the output signal y3 in accordance with Equation (4). However, every 8192 samples (=128×64), that is, each time the initial sample (P1 [1,m]) of the long time frame P2[m] (where m≧2) that is generated by the one-sample delay unit 17 is received, the comparing unit 18 outputs the input signal u4 as the output signal y3. Because the initial value of the one-sample delay (Z⁻¹₃) unit is 0, 0 is outputted during the long time frame P2 [1]. The output signal y3 is stored in the one-sample delay unit 19 and supplied to the comparing unit 18 in the next sample.

$$y 3 = \{ \begin{matrix}u 4 & if i = 1 and n = 1 and m \geq 2 \\ u 5 & otherwise\end{matrix} \qquad ( 4 )$$

The estimated level P2 (m) of the background noise in this particular long time frame P2 [m] is supplied from the comparing unit 18 to the output terminal 20 as the output signal y3 as shown in Equation (5) by means of the comparators 16 and 18 and the one-sample delay units 17 and 19. As shown in FIG. 3, the output signal y3 holds the output signal y2 of the previous long time frame P2 [m−1] during the current long time frame P2 [m].

$$P 2 ( m ) = \{ \begin{matrix} 0 & if m = 1 \\ \begin{matrix} min ( P 1 ( 1 , m - 1 ) , P 1 ( 2 , m - 1 ) , … , \\ P 1 ( 64 , m - 1 ) )\end{matrix} & otherwise\end{matrix} \qquad ( 5 )$$

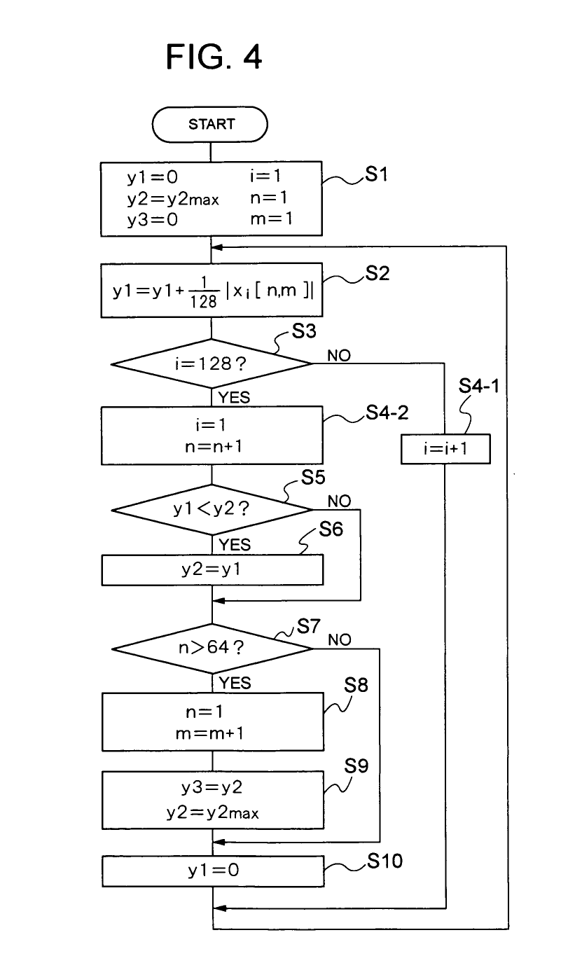

Referring to the flowchart of FIG. 4, the noise level estimation processing performed by the estimation device 9 shown in FIG. 1 will be described.

When the noise level estimation processing starts, the i-th value is initially set at 1, the n-th value is initially set at 1, and the m-th value is initially set at 1. Then, the output signal y1 is set at 0, the output signal y2 is set at the maximum value y2max for the output signal y2, and the output signal y3 is set at 0 (step S1). The absolute value |xᵢ [n,m]| of the i-th sample xᵢ [n,m] in the short time frame P1 [n,m] of the input speech signal x1 is calculated by the absolute value calculating unit 11. The calculation result is multiplied by 1/128 by the multiplying unit 12, and the output signal y1 is added to the multiplication result by the adding unit 13. The output signal y1 (=y1+|xᵢ[n,m]|/128) is generated from the initializing unit 14 (step S2). The initializing unit 14 then determines whether i=128. If i<128, 1 is added to i by the adding unit 13 via the one-sample delay unit 15 (step S4-1). The addition processing is repeated until i=128 is established (steps S2, S3, and S4-1).

When i becomes 128 (i=128), the short time power y1 of the short time frame P1 [n,m] is established and the output signal y1=0 is issued from the initializing unit 14. When the short time power y1 is obtained, the short time frame number n is updated (n=n+1) (step S4-2). When the short time frame is updated, the output signals y2 and y1 are compared by the comparing unit 16 (step S5). If the output signal y1 is smaller than the output signal y2, the output signal y2 is updated with the output signal y1 (step S6). The comparing unit 16 determines whether n>64 (step S7). If n≦64, the update processing of the output signal y2 is repeated (Steps S10, S2 to S7).

When n>64, the comparing unit 18 updates the long time frame number m because 64 short time frames constitute a single long time frame (step S8). Upon this long time frame update, the noise level estimated value (y3) is updated by the comparing unit 18 and the output signal y2 is initialized by the comparing unit 16 (step S9). Furthermore, the short time power (y1) is initialized by the initializing unit 14 (y=0) (step S10). Then, the processing returns to the step S2. As a result, the output signal y3 from the output terminal 20 holds the output signal y2 of the comparing unit 16 in the previous long time frame P2 [m−1], during the current long time frame P2 [m] as shown in FIG. 3.

The first embodiment has the following advantages (a) to (c).

(a) Because a conventional speech detection device is not required, a highly accurate background noise level estimation that does not depend on the detection result of the speech detection device is possible.

(b) Various methods proposed conventionally in order to increase the accuracy of the speech detection device are not necessary and an estimation of the background noise level can be made by means of a smaller circuit scale and/or a smaller calculation amount.

The first embodiment effectively utilizes a fact that a speechless segment having a length of at least single short frame normally exists between phrases even when continuous speech that exceeds the long time frame P2 is continually inputted. As a result, the smallest short time power of a certain long time frame P2 can be taken as an estimated background noise level. Because the calculation of the short time power is carried out for every short time frame P1 (that is, reset to 0 for every short time frame), there is no effect on the estimation result even when the speech signal x1 is contained in another short time frame P1 before or after the short time frame P1 having the smallest short time power.

(c) Because there is no effect on the estimation result, the background noise level of a few segments that exist between phrases can be detected.

### Second Embodiment

For example, in the case of continuous, uninterrupted vocalization, the background noise may not exist over a long time frame or more (i.e., the speech state continues and the background noise cannot be detected over this period). In this instance there is the risk of erroneously estimating the level of the background noise to be larger than it actually is. The first embodiment may not be able to deal with such a case. Specifically, even if the correct background noise level is detected in a short time frame P1 after speech is paused, the detection result is not reflected until the start of the next long time frame P2. The same inconvenience is also caused when the level of the background noise decreases for whatever reason.

In order to resolve the above described problem so as to improve the appropriateness of the noise level estimation, as compared to the first embodiment, the second embodiment has an additional function. Specifically, the comparing unit 18 of the noise level estimation device 9 compares the output signal y2 of the comparing unit 16 with the output signal y3 of the comparing unit 18 upon a short time frame update. If the output signal y2 is smaller than the output signal y1, the comparing unit 18 updates the estimated noise level value y3 with the output signal y2. The functions of the other units 11 to 16 of the noise level estimation device 9 of the second embodiment are the same as those of the first embodiment.

The Noise Level Estimation Method of the Second Embodiment

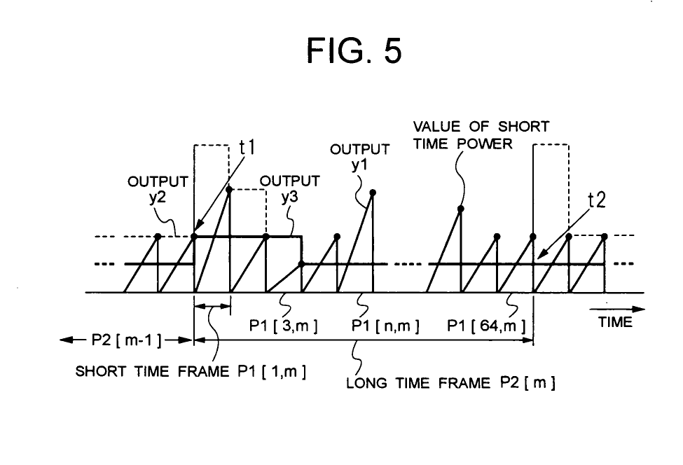

FIG. 5 in the second embodiment corresponds to FIG. 3 in the first embodiment and is a waveform diagram that shows the output signals of the respective units in the noise level estimation device in the second embodiment of the present invention. Time is plotted on the horizontal axis and the signal level is plotted on the vertica axis.

In the second embodiment, the function of the comparing unit 18 is represented by Equation (6).

$$y 3 = \{ \begin{matrix}u 4 & if ( i = 1 and n = 1 and m \geq 2 ) or u 4 < u 5 \\ u 5 & otherwise\end{matrix} \qquad ( 6 )$$

Equation (6) of the second embodiment is a modification of Equation (4) of the first embodiment.

As a result of this modification, the output signal y3 is updated upon formation of each short time frame in the same long time frame (P2[m], for example). Therefore, when the estimated level of the background noise in a certain short time frame P1 [n,m] is denoted by P2 [n,m], Equation (5) is modified to Equation (7). Here, it should be assumed that calculations are performed as far as short time power P1 [n,m].

$$P 2 ( n , m ) = \{ \begin{matrix} 0 & if m = 1 \\ min ( A , B ) & otherwise \\ A = min ( P 1 ( 1 , m - 1 ) , P 1 ( 2 , m - 1 ) , … , P 1 ( 64 , m - 1 ) ) & \\ B = min ( P 1 ( 1 , m ) , P 1 ( 2 , m ) , … , P 1 ( n , m ) ) & \end{matrix} \qquad ( 7 )$$

In Equation (7), the estimated noise level at a start of a long time frame (at time t1 and time t2 in FIG. 5) is the level of the previous output signal y2 and this level is the smallest short time power in the previous long time frame P2 [m−1]. This level is given by A in Equation (7). The smallest short time power in the current long time frame P2 [m] is denoted by B in Equation (7). In the second embodiment, if B is smaller than A, which is the estimated noise level of the long time frame P2 [m] in the first embodiment, the estimated noise level is immediately updated to B. In the second embodiment, therefore, the current noise estimated level P2 (n,m) can be denoted by min (A, B) as shown in Equation (7).

To this end, in the noise level estimation processing of the second embodiment, the initializing unit 14 outputs the value of the short time power at the final sample of the short time frame P1 [n,m] as the output signal y1, as shown in FIG. 5. The output signal y2 of the comparing unit 16 is initialized at the maximum value in the initial sample (P1 [1,m]) of the long time frame P2 [m]. When the smallest short time power is detected in the long time frame P2 [m] (P1 [3,m], for example), this initialized value is updated with the detected smallest short time power by the comparing unit 16. The output signal y3 of the comparing unit 18 holds the output signal y2 of the previous long time frame P2 [m−1] during the current long time frame P2 [m] by means of the comparing unit 18 and the one-sample delay unit 19. However, when the short time power lower than the output signal y3 is detected (P1 [3,m], for example), the output signal y2 is updated with the detected lower short time power by the comparing unit 18.

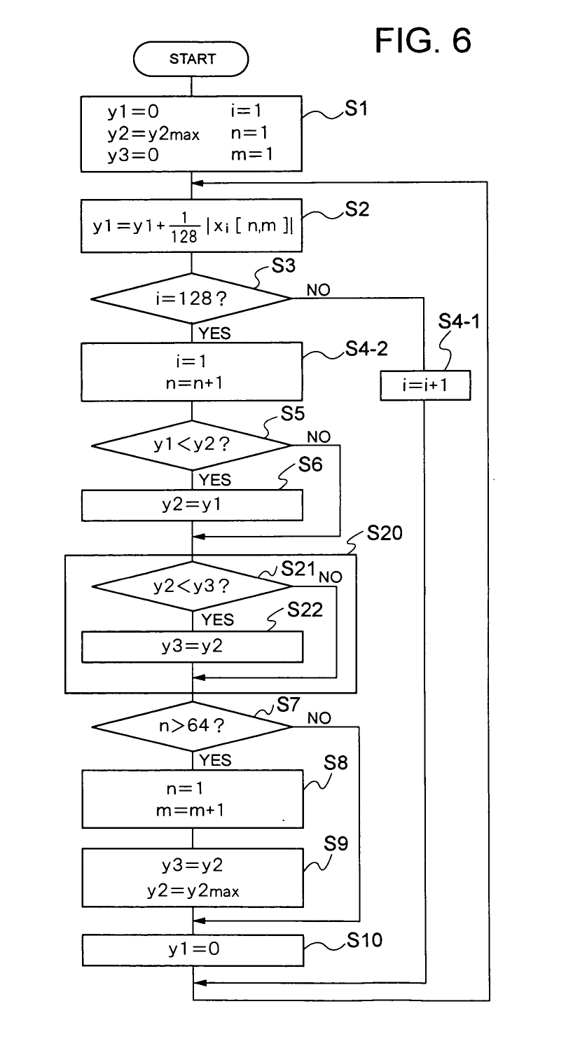

FIG. 6 of the second embodiment corresponds to FIG. 4 of the first embodiment and is a flowchart showing the noise level estimation processing of the second embodiment (FIG. 5).

If FIG. 6 is compared to FIG. 4, the noise level estimation processing of FIG. 6 has an additional step S20 between steps S6 and S7 in FIG. 4. In step S20, the comparing unit 18 of the second embodiment compares the output signal y2 of the comparing unit 16 with the output signal y3 of the comparing unit 18 upon a short time frame update (step S21). If the output signal y2 is smaller than the output signal y3, the comparing unit 18 updates the noise level estimated value y3 with the output signal y2 (step S22). Thereafter, the processing moves to step S7 in the first embodiment.

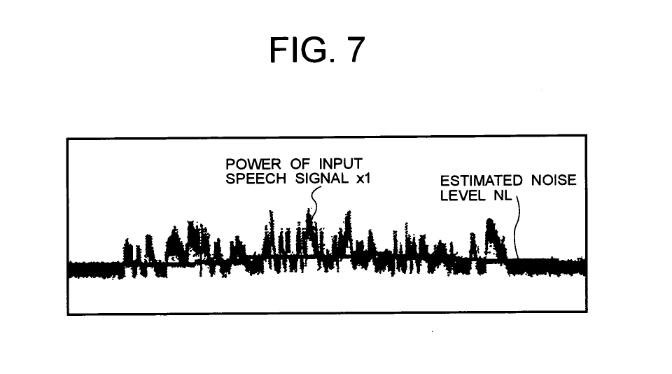

FIG. 7 depicts a waveform diagram of the estimated noise level NL and the power of the input speech signal x1. This waveform diagram shows an example of the noise level estimation of the second embodiment. Time is plotted on the horizontal axis and the level is plotted on the vertical axis.

In the second embodiment, the smallest short time power in a certain long time frame P2 [m] is used as the background noise level. Under this principle, when the short time power lower than the estimated level of the current background noise is detected (at P1[3,m], for example), this detection result is used as the estimated level of the background noise. Thus, the second embodiment achieves better estimation of the noise level than the first embodiment.

In FIG. 7, the background noise is actually made to increase near the center of the diagram. If the second embodiment is adopted, the noise level estimation is performed accurately even when the background noise fluctuates during the inputting of the speech signal x1. Therefore, the estimated background noise level NL shows highly accurate values.

The present invention is not limited to the first and second embodiments. A variety of changes and modifications can be made within the scope of the present invention. For example, the content of steps S1 to S10 and S20 of the noise level estimation processing of FIGS. 4 and 6 can be changed, and the constitution of the noise level estimation device 9 of FIG. 1 is changed in accordance with such changes.

This application is based on a Japanese Patent Application No. 2005-147535 filed on May 20, 2005, and the entire disclosure thereof is incorporated herein by reference.

What is claimed is:

1. A noise level estimation method, wherein a particular segment of an input speech signal is defined as a long time frame, and a plurality of short time frames constitute said long time frame, comprising:
defining a short time frame and a long time frame that includes a plurality of said short time frames;
calculating a short time power of an input speech signal for each of said short time frames;
finding a smallest short time power among the calculated short time powers; and
taking the smallest short time power as an estimated noise level of the input speech signal.

2. The noise level estimation method according to claim 1 further comprising updating, when a short time power smaller than the estimated noise level is detected, the estimated noise level by means of the detected short time power.

3. The noise level estimation method according to claim 1, wherein the estimated noise level is an estimated level of a background noise of the input speech signal.

4. The noise level estimation method according to claim 2, wherein said updating is performed at predetermined intervals.

5. The noise level estimation method according to claim 2, wherein said updating is performed at a start of every said short time frame.

6. The noise level estimation method according to claim 1, wherein said long time frame is constituted by 64 said short time frames.

7. A noise level estimation device, wherein a particular segment of an input speech signal is defined as a long time frame, and a plurality of short time frames constitute said long time frame, said noise level estimation device comprising:
first calculating means for calculating a short time power of the input speech signal for each of said short time frames;
second calculating means for calculating a smallest short time power among the calculated short time powers; and
output means for outputting the smallest short time power as an estimated noise level of the input speech signal.

8. The noise level estimation device according to claim 7, wherein when a short time power smaller than the estimated noise level is detected, the output means updates the estimated noise level by the detected short time power.

9. The noise level estimation device according to claim 7, wherein the estimated noise level is an estimated level of a background noise of the input speech signal.

10. The noise level estimation device according to claim 8, wherein said updating is performed at predetermined intervals.

11. The noise level estimation device according to claim 8, wherein said updating is performed at a start of every said short time frame.

12. The noise level estimation device according to claim 7, wherein said long time frame is constituted by 64 said short time frames.

13. A noise level estimation device wherein a particular segment of an input speech signal is defined as a long time frame, and a plurality of short time frames constitute said long time frame, said noise level estimation device comprising:
a first calculator for calculating a short time power of the input speech signal for each of said short time frames;
a second calculator for calculating a smallest short time power among the calculated short time powers; and
an output unit for outputting the smallest short time power as an estimated noise level of the input speech signal.

14. The noise level estimation device according to claim 13, wherein when a short time power smaller than the estimated noise level is detected, the output unit updates the estimated noise level by the detected short time power.

15. The noise level estimation device according to claim 13, wherein the estimated noise level is an estimated level of a background noise of the input speech signal.

16. The noise level estimation device according to claim 14, wherein said updating is performed at predetermined intervals.

17. The noise level estimation device according to claim 14, wherein said updating is performed at a start of every said short time frame.

18. The noise level estimation device according to claim 13, wherein said long time frame is constituted by 64 said short time frames.
